(19) United States
(12) Patent Application Publication
(10) Pub. No.: US 2026/0146840 A1
(43) Pub. Date: May 28, 2026

(54) Steering Angle Sensor

(71) Applicant: Robert Bosch GmbH, Stuttgart (DE)

(72) Inventors: Jose Azevedo, Braga (PT); Nuno Costa, Braga (PT); Alvaro Magalhaes, Braga (PT)

(21) Appl. No.: 19/393,977

(22) Filed: Nov. 19, 2025

(30) Foreign Application Priority Data
Nov. 22, 2024 (DE) 10 2024 211 240.2

(51) Int. Cl. G01B 7/30; B62D 15/02; G01D 5/20

(52) U.S. Cl. CPC G01B 7/30; B62D 15/0215; G01D 5/20

(57) ABSTRACT

A steering angle sensor for a steering mechanism of a vehicle includes a target coupled to a steering shaft of the steering mechanism and a fixed three-dimensionally shaped coil carrier. The target has at least one metallic target surface aligned tangentially to the steering shaft, and at least one target gap. The coil carrier has at least one coil aligned tangentially to the steering shaft for detecting the target surface.

This application claims priority under 35 U.S.C. § 119 to application no. DE 10 2024 211 240.2, filed on Nov. 22, 2024 in Germany, the disclosure of which is incorporated herein by reference in its entirety.

The disclosure relates to a steering angle sensor for a steering mechanism of a vehicle.

### BACKGROUND

A position sensor can be inductive. An electromagnetic field can be built up via at least one coil. A metallic target that can move relative to the coil is arranged in the field. Eddy currents are induced in the target by the electromagnetic field. The eddy currents counteract the field and disturb the electromagnetic field. The disturbed electromagnetic field is measured and evaluated. A disturbance of the field is different for different positions of the target. The position of the target can therefore be deduced from the disturbed electromagnetic field.

In the case of an inductive steering angle sensor, the target can be coupled to a steering shaft of the steering mechanism. When the steering shaft is rotated, the target is moved past the electromagnetic field or within the electromagnetic field. An angle position of the steering shaft can be deduced from the disturbed electromagnetic field.

The target can be a disk arranged radially with respect to the steering shaft. The disk is flat. Therefore, a printed circuit board with at least one flat coil for transmitting and/or receiving the electromagnetic field can be arranged parallel to the disk. The printed circuit board can be offset to the side of the steering shaft and overlap the disk in one section. The disk can move past the printed circuit board during a steering movement, so that a different section of the disk overlaps the printed circuit board at each angle position of the steering shaft. The steering angle sensor can be mounted easily thanks to the lateral arrangement of the printed circuit board.

### SUMMARY

Against this background, the approach presented here is a steering angle sensor according to description set forth below. Advantageous further developments and improvements of the approach presented here will emerge from the below description as well.

In the approach presented here, the orientation and shape of the target and the at least one coil are spatial or three-dimensional. The target is arranged tangentially to the steering shaft and the at least one coil is also arranged tangentially to the steering shaft parallel to the tangential target.

The approach presented here allows the steering angle sensor to have small dimensions laterally to the steering shaft. In addition, an area in which the target and the at least one coil overlap can be larger than with a radial alignment of the target and lateral arrangement of the coil. In particular, the target and the coil can overlap completely.

Due to the large overlap, a small change in the relative position of the target and coil causes a large change in the electromagnetic field. The major change can be easily measured. Due to the large change in the field, a high angular resolution can be achieved.

A steering angle sensor for a steering mechanism of a vehicle is presented. The steering angle sensor has a target coupled to a steering shaft of the steering mechanism and a fixed, three-dimensionally shaped coil carrier. The target has at least one metallic target surface aligned tangentially to the steering shaft and at least one target gap. The coil carrier has at least one coil aligned tangentially to the steering shaft for detecting the target surface.

Ideas concerning embodiments of the present disclosure may be regarded as being based, among other things, on the thoughts and findings described below.

A steering angle sensor can be part of a steering mechanism of a vehicle. The steering angle sensor should have the highest possible angular resolution. Conventionally, an increased angular resolution can be achieved by increasing the diameter of a measuring scale. Due to the larger diameter, the measuring scale moves a greater distance past a measuring device per angular step than a small measuring scale. The greater distance results in a greater angular resolution.

The steering angle sensor can use an inductive measuring principle. An electromagnetic field is generated using at least one coil and coupled into the measuring scale. The measurement scale is referred to here as the target. The measuring scale has electrically conductive and electrically non-conductive areas. A conductive area can be designated as a target surface. A non-conductive area can be referred to as a target gap. The electromagnetic field couples into a conductive area. The electromagnetic field does not couple into a non-conductive area. Eddy currents are induced in the conductive area by the electromagnetic field. The eddy currents in turn generate an electromagnetic field that is directed in the opposite direction to the generating electromagnetic field and interferes with it. The resulting disturbed field moves due to the relative movement of the target relative to a receiving device. The disturbed electromagnetic field generates an electrical signal in the receiving device. The signal changes due to the relative movement and represents a relative position of the target to the receiving device. The relative position corresponds to the angle position.

As an alternative to the larger diameter, an overlap between the receiving device and the target can be increased. In the approach presented here, the overlap is increased in that the receiving device and the target are spatially shaped and arranged tangentially to the steering shaft. Tangentially arranged can mean here that a surface formed by the receiving device or the target, in particular an inner surface or an outer surface, is formed and arranged circumferentially around the elongated steering shaft. The overlap can be maximum when the target and the receiving device are annular or cylindrical. The receiving device may or may not be closed in an annular shape.

The receiving device can have at least one coil. The coil can be used to transmit and receive the electromagnetic field. Alternatively, different coils can be used for sending and receiving. The at least one coil can be arranged on a three-dimensionally shaped coil carrier The coil carrier can, for example, be three-dimensionally formed by 3D printing or bent from a two-dimensional or flat shape.

The target can be manufactured from a disk-shaped blank. The at least one target surface can be bent up from a plane of the blank. A disk-shaped area of the blank can be arranged between the at least one target surface and the steering shaft. Alternatively, the target surface can be arranged on an electrically insulating carrier of the target. The carrier can be made of a plastic material, for example.

The steering angle sensor can have a second target. The target can be coupled to a first part of the steering shaft. The second target can be coupled to a second part of the steering shaft. The first part and the second part of the steering shaft can be coupled together by a torsion element. The second target can have at least one second metallic target surface aligned tangentially to the second part, as well as at least one second target gap. The coil carrier can have at least one second coil aligned tangentially to the second part for detecting the second target surface. The steering shaft can be split. The parts can be coupled via a torsion bar. The coil carrier can pass through and carry at least one coil for both targets. Thanks to the two targets, the steering angle sensor can also detect a steering torque. The steering torque is proportional to the angular offset between the targets. The angular offset depends on the spring stiffness of the torsion element and the steering torque. The steering angle sensor can therefore be described as a torque steering angle sensor.

At least one rotatably mounted spur gear can engage with the steering shaft. Another metallic target can be coupled to the spur gear. The coil carrier can have at least one additional coil for detecting the additional target. The interference of the electromagnetic field by the additional target can also be detected by the detection device for the target. The steering shaft can have a gearing. The spur gear can have a different number of teeth than the toothing of the steering shaft. The different numbers of teeth result in a transmission ratio. Due to the transmission ratio, the relative position of the additional target to the detection device varies over several revolutions of the steering shaft at the same angle position of the steering shaft. As a result, the disturbance over several revolutions is also different in each case. The steering angle sensor can thus measure an absolute steering angle over several revolutions of the steering shaft.

A thread can be arranged on the steering shaft. A further metallic target can engage in the thread and be mounted so that it cannot rotate but can move axially in relation to the steering shaft. The coil carrier can have at least one additional coil for detecting the additional target. The interference of the electromagnetic field by the additional target can also be detected by the detection device for the target. The thread has a pitch. The thread moves the additional target axially along the steering shaft when the steering shaft is rotated. The additional target is in a different position for each rotation. This results in a different disturbance of the electromagnetic field with each revolution. The steering angle sensor can thus measure an absolute steering angle over several revolutions of the steering shaft.

The thread can be molded onto the steering shaft. An injection-molded thread can be made of a plastic material and injected onto the steering shaft using an injection molding process. The injection-molded thread replaces a cut or milled thread. Since no large forces occur during axial movement of the additional target, plastic can also be used as the thread material.

The steering angle sensor can have a removable calibration stop. The calibration stop can be configured to temporarily hold the additional target in a calibration position for calibrating an angle position of the steering shaft. To calibrate, the steering shaft can be turned until the other target touches the calibration stop. The calibration stop thus defines a predefined position for calibration. After calibration, the steering shaft can be moved past the calibration stop with an increased torque. The calibration stop may then drop.

The coil carrier can be a bent printed circuit board. At least one coil can be easily created on the planar printed circuit board. The printed circuit board can then be rolled up to form a hollow cylinder.

The steering angle sensor can have an evaluation electronics unit. The evaluation electronics unit can be connected to at least one coil of the coil carrier. The evaluation electronics unit can be arranged on a printed circuit board that is positioned radially with respect to the steering shaft and transversely with respect to the coil carrier. The printed circuit board can be planar. This means that electronic components can be easily soldered onto the printed circuit board. The printed circuit board can be connected to the coil carrier via plug-in contacts.

The steering angle sensor can have a housing. The coil carrier can run along a cylindrical or essentially cylindrical inner side of the housing. The coil carrier can be pressed against the inside by a restoring force and held in its three-dimensional shape.

The target can have a plurality of metallic target surfaces aligned tangentially to the steering shaft. A plurality of target gaps can be arranged between the target surfaces. The target surfaces and target gaps can vary in size. The target surfaces can be arranged at different distances from the coil carrier. The target surfaces can have different contours. Due to many target surfaces, the interference of the electromagnetic field can be unique in each angle position. The fault can thus be easily recorded and evaluated.

The target can be a metallic disk aligned radially with respect to the steering shaft. The target surface can be bent orthogonally with respect to the disk. The target can be produced particularly easily from a metal sheet.

### BRIEF DESCRIPTION OF THE DRAWINGS

Embodiments of the disclosure are described in the following with reference to the accompanying drawings, wherein neither the drawings nor the description are to be construed as limiting the disclosure.

FIG. 1 shows an illustration of a steering angle sensor according to an exemplary embodiment.

FIG. 2 shows an illustration of a steering angle sensor according to an exemplary embodiment.

The figures are merely schematic and are not to scale. Identical reference numerals denote identical or functionally identical features.

### DETAILED DESCRIPTION

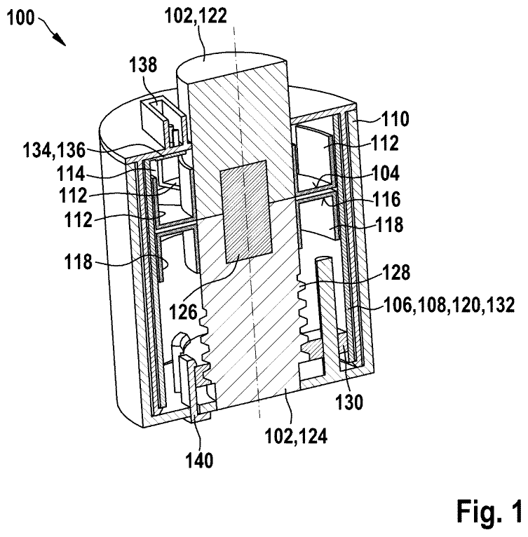

FIG. 1 shows an illustration of a steering angle sensor 100 according to an exemplary embodiment. The steering angle sensor 100 is installed in a steering mechanism of a vehicle and detects an angle position of a steering shaft 102 of the steering mechanism. The steering angle sensor 100 measures the angle position inductively. For this purpose, the steering angle sensor 100 has a target 104 coupled to the steering shaft 102 and at least one coil 108 integrated in a coil carrier 106. The target 104 rotates with the steering shaft 102. The coil carrier is attached to a housing 110 of the steering angle sensor 100.

The target 104 has at least one metallic target surface 112. The target surface 112 is aligned tangentially to the steering shaft 102. The coil 108 is also aligned tangentially to the steering shaft 102 and arranged adjacent to the target 104. The target 104 has at least one target gap 114. The target gap 114 is arranged next to the target surface 112. Here, the target 104 has several target surfaces 112. Here, a target gap 114 is arranged between two target surfaces 112. The target surfaces 112 are distributed around a circumference of the target 104.

In one exemplary embodiment, the target surfaces 112 all have the same distance from the steering shaft 102. As a result, the target surfaces 112 form portions of a cylindrical surface.

In an exemplary embodiment, the target 104 comprises a disk-shaped base body. The base body is aligned orthogonally with respect to the steering axis 102. The base body is made of sheet metal. The target surfaces 112 project perpendicularly from the base body along a circumference of the base body. The target surfaces 112 are bent out of a plane of the base body, for example.

In one exemplary embodiment, the coil carrier 106 is a hollow cylinder and extends along an inner side of the housing 110. The coil carrier 106 is bent round from a flat printed circuit board to form the three-dimensional shape. The at least one coil 108 is formed as a conductor track in the printed circuit board.

In one exemplary embodiment, the steering angle sensor 100 has a second metallic target 116. The second target 116 essentially corresponds to or is similar to the first target 104. The second target also has at least one second target surface 118 aligned tangentially to the steering shaft 102. The coil carrier 106 has at least one second coil 120 for detecting the second target surface 116.

The first target 104 is coupled to an input shaft 122 of the steering angle sensor 100. The second target 116 is coupled to an output shaft 124 of the steering angle sensor 100. The input shaft 122 and the output shaft 124 are mechanically coupled to each other by a torsion element 126. When the torsion element 126 transmits a steering torque from the input shaft 122 to the output shaft 124, the torsion element 126 twists slightly. As a result, the first target 104 and the second target 116 have an angular offset that is proportional to the steering torque. The steering angle sensor 100 is a steering torque steering angle sensor due to the torsion element 126 and the second target 116.

In one exemplary embodiment, the steering shaft 102 has a thread 128. A further metallic target 130 engages in the thread 128. The further target 130 is mounted in the housing 110 so that it can move axially relative to the steering shaft 102. When the steering shaft 102 is rotated, the additional target 130 moves axially along the steering shaft 102. The further target 130 is also detected by at least one further coil 132 of the coil carrier 106. Due to the additional target 130, the steering angle sensor 100 is an absolute steering angle sensor and can output the absolute steering angle even after an interruption in the power supply.

In one exemplary embodiment, the steering angle sensor 100 has evaluation electronics unit 134 on a further printed circuit board 136. The other printed circuit board 136 is flat. The further printed circuit board 136 is disposed perpendicular to the steering shaft 102. The evaluation electronics unit 134 is electrically conductively connected to the at least one coil 108. The further printed circuit board has a plug connector 138 of the steering angle sensor 100. The plug connector 138 can be plugged in the axial direction.

In an exemplary embodiment, the steering angle sensor 100 has a calibration stop 140. The calibration stop 140 fixes the other target 130 for calibrating the steering angle sensor 100 in a predefined calibration position. The calibration stop 140 can be removed after calibration.

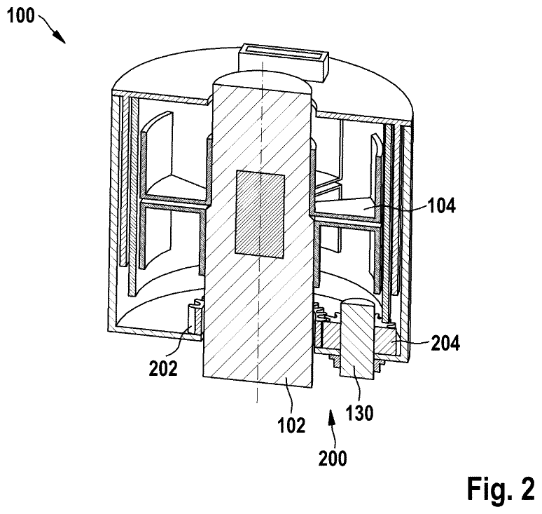

FIG. 2 shows an illustration of a steering angle sensor 100 according to an exemplary embodiment. The steering angle sensor 100 essentially corresponds to the steering angle sensor in FIG. 1. In contrast to this, the steering angle sensor 100 here has a spur gear 200 for counting the revolutions of the steering shaft 102. For this purpose, the steering shaft 102 has a gearing 202 in which a spur gear 204 engages. The other target 130 is connected to the spur gear 204 and rotates with the spur gear 204. The spur gear 200 has a transmission ratio so that the spur gear rotates faster than the steering shaft 102. Due to the transmission ratio, the other target 130 has a different angle position in each revolution over a wide angle range of the steering angle for the same angle position of the steering shaft 102. The angle positions of the target 104 and the other target 130 are evaluated in order to determine the absolute steering angle.

Possible embodiments of the disclosure are summarized again below or presented with a slightly different choice of words.

A radial torque and angle sensor for electrical power steering applications is presented.

A torque and angle sensor (TAS) with inductive technology is presented, which enables an improvement in accuracy, precision and housing size for electric power steering (EPS) applications.

Torque and angle sensors are devices that measure the torque and angle of the steering wheel. The information from the torque measurement is used by the ECU (electronic control device) to calculate the required torque for the steering wheel, which enables the driver to drive smoothly. This type of driving assistance is provided by an electric motor that turns a steering gear with a force that reduces the torque required by the driver, in a system known as EPS (electric power steering).

The information from the angle measurement is used together with information from other sensors for important applications such as ESP (Electronic Stability Program), parking assistance and headlights.

There are five types of electric power steering mechanisms. The column steering mechanism and the rack-and-pinion steering mechanism, the concentric rack-and-pinion steering mechanism and the pinion and double-pinion steering mechanisms. The first two are the most common and make up the majority of power steering mechanisms.

In the column type, the sensor unit and the electric motor are mounted near the steering wheel of the vehicle. In the rack and pinion system, the sensor unit is mounted on the gear rack near the vehicle engine. The choice of one of these systems traditionally depends on the power of the gear rack. Higher forces lead to rack-and-pinion steering, while lower forces typically lead to column steering.

The inductive technology used for the sensor presented here is characterized by EMC immunity (electromagnetic stray fields), high precision and accuracy. Sensors based on the principle of inductive technology can consist of two rotors, one connected to the input shaft and one to the output shaft, and a printed circuit board (with an inductive ASIC and coils) capable of measuring the variation of the signal generated by the two rotors. The signal value is then multiplied by a torsion bar coefficient to calculate the torque signal required to support the drive in electric motors.

The sensor also comprises a central gear wheel attached to the input shaft and a magnetic satellite gear that meshes with the central gear wheel. The magnetic gear wheel generates a magnetic signal that is measured by the sensor element on the printed circuit board.

The system also comprises electric power steering (EPS), which consists of an input shaft, an output shaft, a torsion bar and an ECU control unit that controls the rotation of the engine output torque according to the magnitude.

The approach presented here improves the precision and accuracy of the sensor. Furthermore, an improved housing size or reduced size is achieved. The greatest difficulty in the EPS environment is the very limited space in the radial direction in which the sensor is to be installed. This narrow space is only found in EPS gear racks, which leads to a reduction in the installation space in the steering housing in which the sensor is mounted. The sensor presented here is scaled down in the radial direction.

The torque and angle sensor presented is based on a sensor that uses coils that generate a magnetic field that is disturbed when a metal target moves over it and triggers a response in frequency or amplitude. The sensor described here differs from conventional sensors in the geometry of the metal target, which is bent through ninety degrees in an L-shape. Another distinguishing feature is the shape of the element that contains the measuring tracks. The cylindrical shape of the element allows the wall of the housing to be fully utilized, maximizing the surface area of the coils and targets and thus increasing the inductance generated. A larger inductance generates stronger signals and improves the precision and accuracy of the sensor by using the height of the steering shaft to increase the surface area and achieve this improvement. At the same time, the use of height allows the sensor to have a very small diameter, resulting in a small, compact sensor.

The illustrations show embodiments in which this technology can be used.

In FIG. 1 an embodiment of the torque and angle sensor presented herein is shown. The angle sensor is located on a drive shaft connected to the steering wheel. A torsion bar is arranged between an input rotor and an output rotor. The input rotor and the output rotor are surrounded by a cylindrical sensor element (PCB with coils). A printed circuit board with connector pins is arranged across it. A metal target with a thread is arranged on an output shaft. The target is axially fixed here by a clamp for calibration. The clamp is removed after calibration. The angle sensor is arranged in a housing with a cover.

In this embodiment of the torque and angle sensor, the sensor comprises a cylindrical element with sensing coils (PCB) that produce measurable changes in frequency or amplitude when a disturbance occurs in the magnetic field generated by these coils. It also comprises an “L-shaped” metal target that causes a measurable magnetic disturbance to the coils when a rotary motion is applied to these targets. When the steering wheel turns, the input shaft connected to it starts to turn, while the output shaft connected to the pinion is not yet moving. During this movement, the input shaft encounters the resistance of the torsion bar. Once this resistance is overcome, the output shaft begins to rotate at the same speed as the input shaft, but with an angular offset between the two shafts. The sensor can calculate the steering wheel torque based on the stiffness of the torsion bar and the differential angle of the signal between the two offset targets (input and output rotor).

In this design, there is also a threaded metal target that moves in a “helical” motion due to the shaft rotation in the axial direction, causing a measurable disturbance to the magnetic field, similar to the “L-shaped” metal targets, where each measured frequency or amplitude corresponds directly to a specific angular value of the steering wheel, creating a sensor to measure the angle of rotation. As an option, the thread can be molded onto the shaft.

In FIG. 2, the torque and angle sensor has a spur gear with a metal disk that engages in the output shaft. The spur gear is mounted in a gear holder of the housing.

In this embodiment, the threaded metal target is replaced by a spur gear covered with a metal disk that causes a disturbance of the magnetic field generated by the coils. In this embodiment, the signal from the metal targets is combined with the signal from the spur gear to calculate the angle of rotation.

In both embodiments described, the cylindrical molded element with the sensor coils can be a flexible printed circuit board or an LDS structure.

The approach presented here is characterized by a cylindrical element with inductive coils, metal targets bent by ninety degrees, threaded inductive metal targets or inductive gears measured by a cylindrical coil.

Lastly, it should be noted that terms such as “comprising”, “including”, etc. do not exclude other elements or steps and terms such as “one” or “a” do not exclude a plurality. Reference numerals in the claims should not be construed as limitations.

What is claimed is:

1. A steering angle sensor for a steering mechanism of a vehicle, comprising:
a target coupled to a steering shaft of the steering mechanism; and
a fixed three-dimensionally shaped coil carrier,
wherein the target has at least one metallic target surface aligned tangentially to the steering shaft, and at least one target gap, and
wherein the coil carrier has at least one coil aligned tangentially to the steering shaft and configured to detect the target surface.

2. The steering angle sensor according to claim 1, further comprising a second target, wherein:
the target is coupled to a first part of the steering shaft and the second target is coupled to a second part of the steering shaft,
the first part and the second part of the steering shaft are coupled to each other by a torsion element,
the second target has at least one second metallic target surface aligned tangentially to the second part, and at least one second target gap, and
the coil carrier has at least one second coil aligned tangentially to the second part and is configured to detect the second target surface.

3. The steering angle sensor according to claim 1, further comprising:
at least one rotatably mounted spur gear that engages with the steering shaft, and
a further metallic target that is coupled to the spur gear.

4. The steering angle sensor according to claim 1, further comprising:
a thread arranged on the steering shaft, and
a further metallic target that engages in the thread and is mounted so as to be rotationally fixed but axially movable relative to the steering shaft.

5. The steering angle sensor according to claim 4, wherein the thread is molded onto the steering shaft.

6. The steering angle sensor according to claim 3, further comprising a removable calibration stop, wherein the calibration stop is configured to temporarily hold the further target in a calibration position for calibrating an angle position of the steering shaft.

7. The steering angle sensor according to claim 1, wherein the coil carrier is a bent printed circuit board.

8. The steering angle sensor according to claim 1, further comprising:
a printed circuit board which is arranged radially with respect to the steering shaft and transversely to the coil carrier; and
an evaluation electronics unit connected to at least one coil of the coil carrier, wherein the evaluation electronics unit is arranged on the printed circuit board.

9. The steering angle sensor according to claim 1, further comprising a housing, wherein the coil carrier extends along a substantially cylindrical inner side of the housing.

10. The steering angle sensor according to claim 1, wherein the target has (i) a plurality of metallic target surfaces aligned tangentially to the steering shaft, and (ii) a plurality of target gaps arranged between the target surfaces.

11. The steering angle sensor according to claim 1, wherein:
the target is a metallic disk aligned radially with respect to the steering shaft, and
the target surface is bent orthogonally with respect to the disk.
